(19) United States
(12) Patent Application Publication
(10) Pub. No.: US 2026/0181456 A1
(43) Pub. Date: Jun. 25, 2026

(54) UNIFIED RADIO LINK MONITORING AND BEAM FAILURE DETECTION

(71) Applicant: Nokia Technologies Oy, Espoo (FI)

(72) Inventors: Halit Murat GÜRSU, Munich (DE); Lars DALSGAARD, Oulu (FI); Tero HENTTONEN, Espoo (FI); Faranaz SABOURI-SICHANI, Aalborg (DK); Timo KOSKELA, Oulu (FI); Chitradeep MAJUMDAR, Bangalore (IN)

(73) Assignee: Nokia Technologies Oy, Espoo (FI)

(21) Appl. No.: 19/423,112

(22) Filed: Dec. 17, 2025

(30) Foreign Application Priority Data
Dec. 20, 2024 (IN) 202441101341

(51) Int. Cl. H04W 24/10; H04L 41/0686; H04L 43/0805

(52) U.S. Cl. CPC H04W 24/10; H04L 41/0686; H04L 43/0805

(57) ABSTRACT

A terminal device may be configured to receive, from a serving network device, a configuration message for unified operation of radio link monitoring and beam failure detection, the configuration message comprising an indication to use a timer for early radio link failure, RLF, detection, wherein said timer is configured to be triggered by a transmission of a measurement report associated with a candidate cell to the serving network device in case at least one indication related to a beam failure has been detected by the terminal device; monitor for the at least one indication related to the beam failure; start the timer for early RLF detection based on the transmission of the measurement report and detection of said at least one indication. Devices and methods are disclosed.

### TECHNICAL FIELD

Various example embodiments generally relate to the field of communication technologies. Example embodiments relate to devices and methods enabling unified radio link monitoring (RLM) and beam failure detection (BFD).

### BACKGROUND

In wireless communication, a user equipment (UE) may communicate with access nodes of a cellular radio network via radio links established within cells. Radio link monitoring may be utilized to assess the quality of a radio link and detect conditions leading to radio link failure (RLF). Beam failure detection may be separately employed to monitor the quality of individual beams used for communication and to detect beam-specific failures. These mechanisms typically operate independently, with distinct processes for detecting and recovering from failures.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments of the present disclosure enable to ensure that radio link failures are detected and recovered efficiently. This and other benefits may be achieved by the features of the independent claims. Further example embodiments are provided in the dependent claims, the description, and the drawings.

According to a first aspect, a terminal device is disclosed. The terminal device may comprise: at least one processor; and at least one memory storing instructions that, when executed by the at least one processor, cause the terminal device at least to receive, from a serving network device, a configuration message for unified operation of radio link monitoring and beam failure detection, the configuration message comprising an indication to use a timer for early radio link failure, RLF, detection, wherein said timer is configured to be triggered by a transmission of a measurement report associated with a candidate cell to the serving network device in case at least one indication related to a beam failure has been detected by the terminal device; monitor for the at least one indication related to the beam failure; start the timer for early RLF detection based on the transmission of the measurement report and detection of said at least one indication.

According to an example embodiment of the first aspect, the instructions, when executed by the at least one processor, further cause the terminal device to declare radio link failure based on expiry of the timer for early RLF detection.

According to an example embodiment of the first aspect, the instructions, when executed by the at least one processor, further cause the terminal device to determine that said at least one indication has been detected based on at least one of one or more beam failure indications received by the terminal device or based on a beam failure recovery procedure ongoing at the terminal device.

According to an example embodiment of the first aspect, the instructions, when executed by the at least one processor, further cause the terminal device to determine that a reference signal of the candidate cell is an offset stronger than a reference signal of a serving cell or stronger than a threshold; and perform the transmission of the measurement report associated with the candidate cell to the serving network device based on the determination.

According to an example embodiment of the first aspect, the instructions, when executed by the at least one processor, further cause the terminal device to determine that said at least one indication has been detected; and based on the determination, include an indication that the timer for early RLF detection is started to the measurement report associated with the candidate cell.

According to an example embodiment of the first aspect, the instructions, when executed by the at least one processor, further cause the terminal device to receive, from the serving network device, at least one of a cell change command or a beam change command; and determine to stop the timer for early RLF detection based on at least one of the cell change command or the beam change command received before expiry of the timer for early RLF detection.

According to an example embodiment of the first aspect, the configuration message further comprises an indication to disable usage of a timer for RLF detection configured to be triggered based on radio link monitoring when the timer for early RLF detection is configured to be used; and wherein the instructions, when executed by the at least one processor, further cause the terminal device to disable, based on the indication, trigger of the timer for RLF detection based on radio link monitoring performed on the serving network device.

According to an example embodiment of the first aspect, the timer for RLF detection is a T310 timer.

According to an example embodiment of the first aspect, the timer for early RLF detection is a T312 timer.

According to an example embodiment of the first aspect, the configuration message further comprises initial parameters for triggering the beam failure detection, the initial parameters comprising at least one of a maximum number of consecutive out-of-sync indications, a beam failure indication timer or a beam failure indication counter value.

According to an example embodiment of the first aspect, the configuration message further comprises an indication that subsequent parameters are received via a medium access control message; and wherein the instructions, when executed by the at least one processor, further cause the terminal device to: receive the parameters via the medium access message; and apply the parameters received via the medium access control message for radio problem detection.

According to a second aspect, a method is disclosed. The method may comprise receiving, by a terminal device from a serving network device, a configuration message for unified operation of radio link monitoring and beam failure detection, the configuration message comprising an indication to use a timer for early radio link failure, RLF, detection, wherein said timer is configured to be triggered by a transmission of a measurement report associated with a candidate cell to the serving network device in case at least one indication related to a beam failure has been detected by the terminal device; monitor for the at least one indication related to the beam failure; start the timer for early RLF detection based on the transmission of the measurement report and detection of said at least one indication.

According to an example embodiment of the second aspect, the method may comprise declaring, by the terminal device, radio link failure based on expiry of the timer for early RLF detection.

According to an example embodiment of the second aspect, the method may comprise determining, by the terminal device, that said at least one indication has been detected based on at least one of one or more beam failure indications received by the terminal device or based on a beam failure recovery procedure ongoing at the terminal device.

According to an example embodiment of the second aspect, the method may comprise determining, by the terminal device, that a reference signal of the candidate cell is an offset stronger than a reference signal of a serving cell or stronger than a threshold; and performing, by the terminal device, the transmission of the measurement report associated with the candidate cell to the serving network device based on the determination.

According to an example embodiment of the second aspect, the method may comprise determining, by the terminal device, that said at least one indication has been detected; and based on the determination, including an indication that the timer for early RLF detection is started to the measurement report associated with the candidate cell.

According to an example embodiment of the second aspect, the method may comprise receiving, by the terminal device from the serving network device, at least one of a cell change command or a beam change command; and determining, by the terminal device, to stop the timer for early RLF detection based on at least one of the cell change command or the beam change command received before expiry of the timer for early RLF detection.

According to an example embodiment of the second aspect, the configuration message further comprises an indication to disable usage of a timer for RLF detection configured to be triggered based on radio link monitoring when the timer for early RLF detection is configured to be used; and wherein the method comprises disabling, by the terminal device based on the indication, trigger of the timer for RLF detection based on radio link monitoring performed on the serving network device.

According to an example embodiment of the second aspect, the timer for RLF detection is a T310 timer.

According to an example embodiment of the second aspect, the timer for early RLF detection is a T312 timer.

According to an example embodiment of the second aspect, the configuration message further comprises initial parameters for triggering the beam failure detection, the initial parameters comprising at least one of a maximum number of consecutive out-of-sync indications, a beam failure indication timer or a beam failure indication counter value.

According to an example embodiment of the second aspect, the configuration message further comprises an indication that subsequent parameters are received via a medium access control message; and wherein method comprises receiving, by the terminal device, the parameters via the medium access message; and applying, by the terminal device, the parameters received via the medium access control message for radio problem detection.

According to a third aspect, a network device is disclosed. The network device may comprise: at least one processor; and at least one memory storing instructions that, when executed by the at least one processor, cause the network device at least to determine to configure a terminal device to use a timer for early radio link failure, RLF, detection for unified operation of radio link monitoring and beam failure detection, wherein said timer is configured to be triggered by a transmission of a measurement report associated with a candidate cell to a serving network device in case at least one indication related to a beam failure has been detected by the terminal device; and send, to the terminal device, a configuration message for unified operation of radio link monitoring and beam failure detection comprising an indication to use the timer for early RLF detection.

According to an example embodiment of the third aspect, the instructions, when executed by the at least one processor, further cause the network device to: receive, from the terminal device, the measurement report associated with a candidate cell comprising an indication that said timer is started; and prioritize transmission of a cell change command to the terminal device based on the received indication.

According to an example embodiment of the third aspect, the terminal device is determined to be configured for the unified operation based on the network device being a serving network node of the terminal device and supporting multiple beam operation.

According to an example embodiment of the third aspect, the instructions, when executed by the at least one processor, further cause the network device to: determine, based on statistical information, that beam failure recovery procedure results in successful re-establishment of connection; and determine to configure the terminal device for the unified operation based on the determination.

According to an example embodiment of the third aspect, the instructions, when executed, further cause the network device to obtain, from a medium access control layer of the network device, initial parameters for the beam failure detection comprising at least one of a maximum number of consecutive out-of-sync indications, a beam failure indication timer or a beam failure indication counter value to be used by the terminal device for the beam failure detection; and wherein the configuration message further comprises the initial parameters.

According to an example embodiment of the third aspect, the configuration message comprises an indication that subsequent parameters are received by the terminal device via a medium access control message, and the instructions, when executed by the at least one processor, further cause the network device to determine said parameters by the medium access control layer; and send the determined parameters to the terminal device via the medium access control message.

According to an example embodiment of the third aspect, the at least one indication related to a beam failure detection comprises at least one of one or more beam failure indications received by the terminal device or an ongoing beam failure recovery procedure at the terminal device.

According to an example embodiment of the third aspect, the measurement report associated with the candidate cell is received from the terminal device when a reference signal of the candidate cell if an offset stronger than a reference signal of a serving cell or stronger than a threshold.

According to an example embodiment of the third aspect, the configuration message further comprises an indication to disable use of a timer for RLF detection configured to be triggered based on radio link monitoring when the timer for early RLF detection is configured to be used by the terminal device.

According to a fourth aspect, a method is disclosed. The method may comprise determining, by a network device, to configure a terminal device to use a timer for early radio link failure, RLF, detection for unified operation of radio link monitoring and beam failure detection, wherein said timer is configured to be triggered by a transmission of a measurement report associated with a candidate cell to a serving network device in case at least one indication related to a beam failure has been detected by the terminal device; and sending, by the network device to the terminal device, a configuration message for unified operation of radio link monitoring and beam failure detection comprising an indication to use the timer for early RLF detection.

According to an example embodiment of the fourth aspect, the method may comprise receiving, by the network device from the terminal device, the measurement report associated with a candidate cell comprising an indication that said timer is started; and prioritizing, by the network device, transmission of a cell change command to the terminal device based on the received indication.

According to an example embodiment of the fourth aspect, the terminal device is determined to be configured for the unified operation based on the network device being a serving network node of the terminal device and supporting multiple beam operation.

According to an example embodiment of the fourth aspect, the method may comprise determining, by the network device based on statistical information, that beam failure recovery procedure results in successful re-establishment of connection; and determining to configure the terminal device for the unified operation based on the determination.

According to an example embodiment of the fourth aspect, the method may comprise obtaining, by the network device from a medium access control layer of the network device, initial parameters for the beam failure detection comprising at least one of a maximum number of consecutive out-of-sync indications, a beam failure indication timer or a beam failure indication counter value to be used by the terminal device for the beam failure detection; and wherein the configuration message further comprises the initial parameters.

According to an example embodiment of the fourth aspect, the configuration message comprises an indication that subsequent parameters are received by the terminal device via a medium access control message, and the method comprises determining, by the network device, said parameters by the medium access control layer; and sending, by the network device, the determined parameters to the terminal device via the medium access control message.

According to an example embodiment of the fourth aspect, the at least one indication related to a beam failure detection comprises at least one of one or more beam failure indications received by the terminal device or an ongoing beam failure recovery procedure at the terminal device.

According to an example embodiment of the fourth aspect, the measurement report associated with the candidate cell is received from the terminal device when a reference signal of the candidate cell if an offset stronger than a reference signal of a serving cell or stronger than a threshold.

According to an example embodiment of the fourth aspect, the configuration message further comprises an indication to disable use of a timer for RLF detection configured to be triggered based on radio link monitoring when the timer for early RLF detection is configured to be used by the terminal device.

According to a fifth aspect a terminal device is provided. The terminal device comprises at least one processor; and at least one memory storing instructions that, when executed by the at least one processor, cause the terminal device at least to receive, from a network device, a first set of radio problem detection parameters for radio link monitoring; receive, from the network device, an indication of a second set of radio problem detection parameters via a lower layer message; and apply the second set of radio problem detection parameters for radio link monitoring. wherein applying the second set of radio problem detection parameters for radio link monitoring causes a radio link problem to be detected with less or more severe radio link problems than when applying the first set of radio problem detection parameters.

According to an example embodiment of the fifth aspect, the instructions, when executed by the at least one processor, further cause the terminal device to receive, from the network device, an indication that the indication of the second set of radio problem detection parameters will be indicated via the lower layer message.

According to an example embodiment of the fifth aspect, the lower layer message is a medium access control, MAC, message.

According to an example embodiment of the fifth aspect, the instructions, when executed by the at least one processor, further cause the terminal device to: receive a first reference signal from the network device; receive a second reference signal from the network device; perform at last one measurement on the first reference signal and the second reference signal; transmit, based on the at least one measurement on the first reference signal and the second reference signal, a measurement report to the network device.

According to an example embodiment of the fifth aspect, the first reference signal is an indicated beam of the terminal device.

According to an example embodiment of the fifth aspect, the instructions, when executed by the at least one processor, further cause the terminal device to: perform, based on the at least one measurement, a comparison of the first reference signal and the second reference signal; determine, based on the comparison, that the second reference signal is stronger than the first reference signal; and wherein the measurement report comprises a result of the comparison.

According to an example embodiment of the fifth aspect, the instructions, when executed by the at least one processor, further cause the terminal device to: receive, from the network device, a beam change command to configure the second reference signal as an indicated beam of the terminal device.

According to an example embodiment of the fifth aspect, the indication of the second set of radio problem detection parameters comprises at least one of:
a decreased N310 counter limit;
an increased N310 counter limit;
an increased beam failure indication, BFI, detection timer value;
a decreased BFI detection timer value;
a decreased BFI max count;
an increased BFI max count;
an increased or decreased T310 value;
an increased or decreased Qout value;
beam failure recovery configuration or preamble; or
a radio link monitoring reference signal.

According to an example embodiment of the fifth aspect, the indication of the second set of radio problem detection parameters comprises at least one instruction to adjust the first set of radio problem detection parameters to obtain the second set of radio problem detection parameters.

According to a sixth aspect, a method is disclosed. The method may comprise receiving, by a terminal device from a network device, a first set of radio problem detection parameters for radio link monitoring; receiving, by the terminal device from the network device, an indication of a second set of radio problem detection parameters via a lower layer message; and applying, by the terminal device, the second set of radio problem detection parameters for radio link monitoring. wherein applying the second set of radio problem detection parameters for radio link monitoring causes a radio link problem to be detected with less or more severe radio link problems than when applying the first set of radio problem detection parameters.

According to an example embodiment of the sixth aspect, the method may comprise receiving, by the terminal device from the network device, an indication that the indication of the second set of radio problem detection parameters will be indicated via the lower layer message.

According to an example embodiment of the sixth aspect, the lower layer message is a medium access control, MAC, message.

According to an example embodiment of the sixth aspect, the method may comprise: receiving, by the terminal device, a first reference signal from the network device; receiving, by the terminal device, a second reference signal from the network device; performing, by the terminal device, at last one measurement on the first reference signal and the second reference signal; transmitting, by the terminal device, based on the at least one measurement on the first reference signal and the second reference signal, a measurement report to the network device.

According to an example embodiment of the sixth aspect, the first reference signal is an indicated beam of the terminal device.

According to an example embodiment of the sixth aspect, the method may comprise performing, by the terminal device, based on the at least one measurement, a comparison of the first reference signal and the second reference signal; determining, by the terminal device based on the comparison, that the second reference signal is stronger than the first reference signal; and wherein the measurement report comprises a result of the comparison.

According to an example embodiment of the sixth aspect, the method may comprise receiving, by the terminal device from the network device, a beam change command to configure the second reference signal as an indicated beam of the terminal device.

According to an example embodiment of the sixth aspect, the indication of the second set of radio problem detection parameters comprises at least one of:
a decreased N310 counter limit;
an increased N310 counter limit;
an increased beam failure indication, BFI, detection timer value;
a decreased BFI detection timer value;
a decreased BFI max count;
an increased BFI max count;
an increased or decreased T310 value;
an increased or decreased Qout value;
beam failure recovery configuration or preamble; or
a radio link monitoring reference signal.

According to an example embodiment of the sixth aspect, the indication of the second set of radio problem detection parameters comprises at least one instruction to adjust the first set of radio problem detection parameters to obtain the second set of radio problem detection parameters.

According to a seventh aspect, a network device is provided. The network device comprises at least one processor; and at least one memory storing instructions that, when executed by the at least one processor, cause the network device at least to: transmit, to a terminal device, a first set of radio problem detection parameters for radio link monitoring; determine that the terminal device is to apply a second set of radio problem detection parameters for radio link monitoring, wherein applying the second set of radio problem detection parameters for radio link monitoring causes a radio link problem to be detected with less or more severe radio link problems than when applying the first set of radio problem detection parameters; and transmit, to the terminal device, an indication of the second set of radio problem detection parameters via a lower layer message.

According to an example embodiment of the seventh aspect, the instructions, when executed by the at least one processor, further cause the network device to: transmit, to the terminal device, an indication that the indication of the second set of radio problem detection parameters will be indicated via the lower layer message.

According to an example embodiment of the seventh aspect, the determining that the terminal device is to apply the second set of radio problem detection parameters for radio link monitoring is based on a measurement report received from the terminal device.

According to an example embodiment of the seventh aspect, the instructions, when executed by the at least one processor, further cause the network device to: transmit a first reference signal to the terminal device, wherein the first reference signal is an indicated beam of the terminal device; transmit a second reference signal to the terminal device; and receive a measurement report comprising at least one measurement result of the first reference signal and the second reference signal or a result of a comparison of the first reference signal and the second reference signal.

According to an example embodiment of the seventh aspect, the instructions, when executed by the at least one processor, further cause the network device to: determine, based on the measurement report, that the second reference signal is stronger than the first reference signal.

According to an example embodiment of the seventh aspect, the instructions, when executed by the at least one processor, further cause the network device to: transmit, to the terminal device, a beam change command to configure the second reference signal as an indicated beam of the terminal device.

According to an example embodiment of the seventh aspect, the indication of the second set of radio problem detection parameters comprises at least one of:
a decreased N310 counter limit;
an increased N310 counter limit;
an increased beam failure indication, BFI, detection timer value;
a decreased BFI detection timer value;
a decreased BFI max count;
an increased BFI max count;
an increased or decreased T310 value;
an increased or decreased Qout value;
beam failure recovery configuration or preamble; or
a radio link monitoring reference signal.

According to an example embodiment of the seventh aspect, the indication of the second set of radio problem detection parameters comprises at least one instruction to adjust the first set of radio problem detection parameters to obtain the second set of radio problem detection parameters.

According to an eight aspect, a method is provided. The method may comprise: transmitting, by a network device to a terminal device, a first set of radio problem detection parameters for radio link monitoring; determining, by the network device, that the terminal device is to apply a second set of radio problem detection parameters for radio link monitoring, wherein applying the second set of radio problem detection parameters for radio link monitoring causes a radio link problem to be detected with less or more severe radio link problems than when applying the first set of radio problem detection parameters; and transmitting, by the network device to the terminal device, an indication of the second set of radio problem detection parameters via a lower layer message.

According to an example embodiment of the eight aspect, the method may comprise transmitting, by the network device to the terminal device, an indication that the indication of the second set of radio problem detection parameters will be indicated via the lower layer message.

According to an example embodiment of the eight aspect, the determining that the terminal device is to apply the second set of radio problem detection parameters for radio link monitoring is based on a measurement report received from the terminal device.

According to an example embodiment of the eight aspect, the method may comprise transmitting, by the network device, a first reference signal to the terminal device, wherein the first reference signal is an indicated beam of the terminal device; transmitting, by the network device, a second reference signal to the terminal device; and receiving, by the network device, a measurement report comprising at least one measurement result of the first reference signal and the second reference signal or a result of a comparison of the first reference signal and the second reference signal.

According to an example embodiment of the eight aspect, the method may comprise determining, based on the measurement report, that the second reference signal is stronger than the first reference signal.

According to an example embodiment of the eight aspect, the method may comprise transmitting, by the network device to the terminal device, a beam change command to configure the second reference signal as an indicated beam of the terminal device.

According to an example embodiment of the eight aspect, the indication of the second set of radio problem detection parameters comprises at least one of:
a decreased N310 counter limit;
an increased N310 counter limit;
an increased beam failure indication, BFI, detection timer value;
a decreased BFI detection timer value;
a decreased BFI max count;
an increased BFI max count;
an increased or decreased T310 value;
an increased or decreased Qout value;
beam failure recovery configuration or preamble; or
a radio link monitoring reference signal.

According to an example embodiment of the eight aspect, the indication of the second set of radio problem detection parameters comprises at least one instruction to adjust the first set of radio problem detection parameters to obtain the second set of radio problem detection parameters.

According to a ninth aspect, an apparatus is disclosed. The apparatus may comprise means for performing the method according to the second, fourth, sixth or eight aspect, or any example embodiment(s) thereof, as provided in the description and/or the claims.

According to a tenth aspect, a computer program, a computer program product, or a (non-transitory) computer-readable medium is disclosed. The computer program, computer program product, or (non-transitory) computer-readable medium may comprise instructions, which when executed by an apparatus, cause the apparatus at least to perform the method according to the second, fourth, sixth or eight aspect, or any example embodiment(s) thereof, as provided in the description and/or the claims.

Example embodiments of the present disclosure can thus provide apparatuses, methods, computer programs, computer program products, or computer readable media for improving various aspects of radio link failure detection. Any example embodiment may be combined with one or more other example embodiments. These and other aspects of the present disclosure will be apparent from the example embodiment(s) described below. According to some aspects, there is provided the subject matter of the independent claims. Some further aspects are defined in the dependent claims.

### DESCRIPTION OF THE DRAWINGS

The accompanying drawings, which are included to provide a further understanding of the example embodiments and constitute a part of this specification, illustrate example embodiments and, together with the description, help to explain the example embodiments. In the drawings:

FIG. 1 illustrates an example of a communication network;

FIG. 2 illustrates an example of radio link monitoring and beam failure detection procedures running in parallel at a UE;

FIG. 3 illustrates an example of an apparatus configured to practice one or more example embodiments;

FIG. 4 illustrates an example of participation of different protocol layers of a device in the unified RLM and BFD procedure;

FIG. 5 illustrates an example of a message sequence chart for preparation of the unified RLM and BFD procedure;

FIG. 6 illustrates an example of a message sequence chart for early radio link failure detection mechanism with beam failure detection;

FIG. 7 illustrates an example of a message sequence chart for an early radio link failure detection mechanism and enabling medium access control layer to change radio link monitoring configurations;

FIG. 8 illustrates an of a method for unified operation of radio link monitoring and beam failure detection;

FIG. 9 illustrates an example of a method for configuring unified operation of radio link monitoring and beam failure detection;

FIG. 10 illustrates an example of a method for radio problem detection parameter updates; and

FIG. 11 illustrates an example of a method for configuring radio problem detection parameters;

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

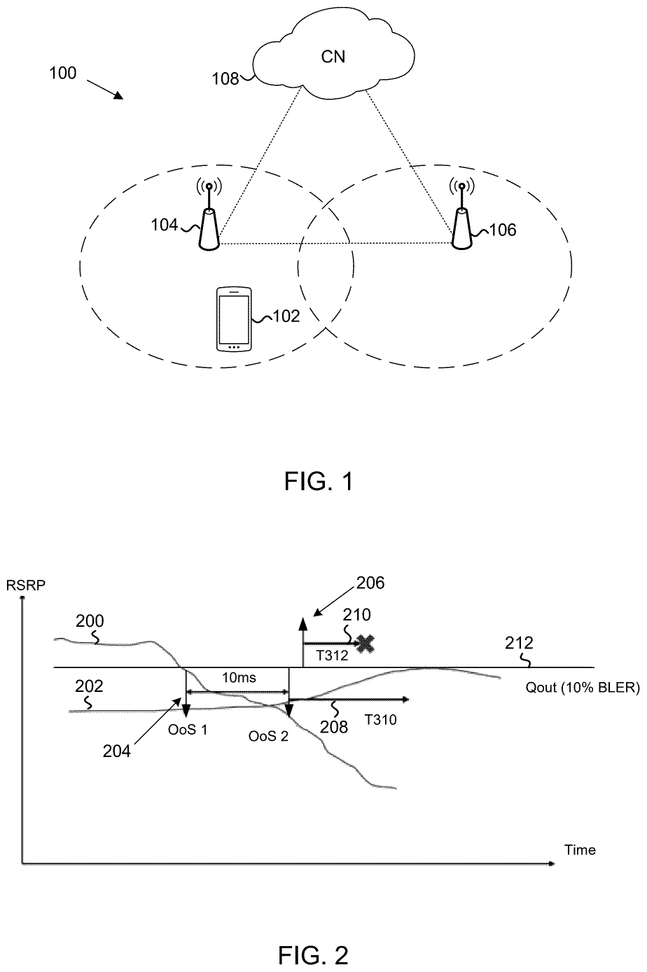

FIG. 1 illustrates an example of a communication network. Communication network 100 may comprise one or more access nodes. Access nodes may be also referred to as network devices, base stations or network nodes. The access nodes may comprise, for example, a gNB 104 and a gNB 106. Access node(s) may be part of a radio access network (RAN) configured to enable a device, represented throughout the description by UE 102, to access communication services provided by core network 108. In connection with communication network 100, access node(s) 104, 106 and core network 108 may be collectively referred to as the ‘network’. UE 102 may comprise a user device, a user node, a terminal apparatus, a terminal device, a mobile device, or the like. A terminal device may refer to any device capable of sending and/or receiving information over a communication channel. UE 102 may be configured to communicate with access node(s) over a radio interface, which may be also referred to as an air interface.

The radio interface may be configured for example based on the 5G NR (New Radio) standard defined by the 3^{rd} Generation Partnership Project (3GPP), or any future standard or technology (e.g., 6G). The gNBs 104, 106 may comprise, for example, 5^{th} generation access nodes or 6^{th} generation access nodes. Transmission by an access node to UE 102 may be called downlink (DL) transmission. Transmission by UE 102 to an access node may be called uplink (UL) transmission. UE 102 may be therefore configured to operate as a transmitter for uplink transmissions and as a receiver for downlink transmissions. The gNB(s) 104, 106 may be configured to operate as a receiver for uplink transmissions and as a transmitter for downlink transmissions. Communication network 100 may comprise a wireless communication network or a mobile communication network, such as for example a cellular communication network.

Core network 108 may be implemented with various network functions (NF), including, for example, one or more user plane functions (UPF) and one or more access and mobility management functions (AMF). A UPF may be configured to handle user data part of a communication session. A UPF may thus provide an interconnect point between the radio access network and a data network configured to provide application services to UE 102 via core network 108 and the radio access network. For example, a UPF may be configured to handle encapsulation and decapsulation of user plane protocol(s), such as the GPRS (general packet radio service) tunnelling protocol for the user plane (GTP-U). An AMF may be configured to receive connection and session request related data from UE 102 (e.g., via an access node). An AMF may be configured to control connection and mobility management in communication network 100.

Access nodes may be configured to communicate with UEs via one or more cells. For example, gNB 104 may be configured to serve UEs at a cell 110. Network node 106 may be configured to serve UEs at a cell 112. An access node may be also configured to serve more than one cell. A cell may be configured to serve UEs at a certain geographical area at a certain radio frequency, or, a range of radio frequencies around a centre frequency of the cell. A serving cell may refer to a cell currently providing radio communication to UE 102. It may support data transmission and reception for UE 102 through the corresponding access node, such as gNB 104. In contrast, a candidate cell may refer to a neighboring or alternate cell that the UE 102 may potentially connect to, typically identified during handover or mobility management procedures. Candidate cells may be selected based on predefined criteria, including signal quality and network conditions. Similarly, a serving network node may describe the access node that is actively supporting UE 102 through the serving cell. A candidate network node, also referred to as a target network node, may describe an access node associated with a candidate cell, which may be selected to replace the serving network node during a handover, thereby maintaining seamless communication and service continuity for UE 102.

Communication network 100 may be operated based on a protocol stack comprising a plurality of protocol layers. The protocol stack may be arranged based on the open systems interconnection (OSI) model or a layer model of a particular standard such as 3GPP 5G NR. As one example, the protocol stack may comprise a physical (PHY) layer or Layer 1 (L1). The PHY layer may be responsible for actual transmission and reception of data over the air interface. PHY layer may further perform (de)modulation, error detection and correction, and resource allocation based on instructions from higher layers. The higher layers may comprise Layer 2 (L2) with a medium access control (MAC) layer. The MAC layer may manage how and when the physical layer should transmit data, ensuring efficient use of resources. The MAC layer may further allocate resources to different users based on scheduling algorithms and handle retransmissions, for example according to the hybrid automatic repeat request (HARQ) process. L2 may further comprise other sub layers, such as a radio link control (RLC), a packet data convergence protocol (PDCP) and a service data adaptation protocol (SDAP).

The higher layers further comprise a radio resource control (RRC) layer or Layer 3 (L3). The RRC layer may manage various aspects of radio resource control, ensuring efficient use of radio spectrum and handling signaling between UE and the network. Key responsibilities of the RRC layer include connection setup and release, mobility management and handover procedures when UE moves from one cell to another, and measurement reporting of signal strength measurements for neighboring cells. Corresponding protocol stacks may be applied both at network devices, such as gNB 104 and gNB 106, and terminal devices, such as UE 102.

In a split access node architecture, part of the protocol layers may be implemented at a central unit (CU) of an access node, e.g., a gNB-CU, which may be configured to handle upper layers of the protocol stack, for example SDAP and PDCP layers. Furthermore, the central unit may be configured to handle radio resource control (RRC) operations. A central unit of an access node may be associated with, e.g., configured to control, one or more distributed units (DU) of the access node, e.g., gNB-DU, which may be configured to handle lower layers of the protocol stack, for example RLC, MAC, and L1. Radio unit(s) of the distributed unit(s) may be configured to transmit/receive data to/from UE(s) over the radio interface. A central unit may be referred to as a central node and a distributed unit may be referred to as a distributed node.

Communication network 100 may comprise other network function(s), network device(s), or protocol(s), in addition, or alternative to, those illustrated in FIG. 1. A network device may be configured to implement functionality of one or more network functions. Even though some embodiments have been described in the context of 5G, it is appreciated that embodiments of the present disclosure are not limited to this example network. Example embodiments may be therefore applied in any present or future communication networks. An apparatus, such as for example UE 102 or gNB 104, 106, may comprise, or be configured to implement, e.g., by means of software, one or more of the protocol layers described herein.

FIG. 2 illustrates an example of radio link monitoring at a UE. Beam failure detection may be separately employed to monitor the quality of individual beams used for communication and to detect beam-specific failures. These mechanisms typically operate independently, with distinct processes for detecting and recovering from failures. In general, a terminal device, such as the UE 102, can be configured with different kinds of timers associated with radio link failure procedures.

In a radio link monitoring (RLM) procedure, the UE 102 may receive in-sync (IS) and out-of-sync (OoS) indications from Layer 1 for a group of configured beams, such as a first beam 200 and a second beam 202 of a serving cell. The first beam 200 may be an indicated beam of the UE 102. Indicated beam may refer to a specific beam, within a group of configured beams in a serving cell, that has been selected or identified for use in DL/UL communication between the UE 102 and network node. The UE 102 monitors quality of the indicated beam, using reference signals, to determine whether the connection is stable or not. If the UE 102 receives a sufficient OoS indication, a timer for radio link failure detection can be started. One example of a timer for RLF detection for RLM is T310. For example, the T310 timer 208 may be configured to be triggered based on two out of sync indications 204 (OoS 1 and OoS 2) detected within 10 ms apart from each other. The UE 102 may be configured to indicate OoS to higher layers based on the radio link quality (estimated e.g. based on reference signals of the first beam 200) falling below a OoS threshold (e.g., Qout=10% block error rate (BLER)) 212. Qout may be defined as the level at which downlink radio link cannot be reliably received. The UE 102 may be further configured to estimate the radio link quality based on a threshold Qin. Qin may be defined as the level at which the downlink radio link quality can be significantly more reliably received than at Qout. Both Qout and Qin may be derived based on hypothetical PSCCH transmission parameters and may correspond to BLER rates indicated by the network. If the UE 102 detects that radio is recovered (e.g., UE 102 receives a sufficient IS indication when RSRP of the first beam is above the Qin threshold) while the failure detection timer T310 is running, the failure detection timer can be stopped. Otherwise, RLF may be triggered by the UE 102 when the T310 timer 208 expires. The RLM may be performed by the RRC layer.

In one approach, UE 102 can be also configured with a T312 timer 210 for early radio link failure detection, which is configured to be triggered while the T310 timer 208 is running and when the UE 102 reports a candidate cell with a measurement report 206 to the network during observed radio problems with a serving cell. After a L3 measurement report is sent by the UE 102 to the network, the UE 102 may expect the network to send a handover command. In case no HO command is received from the network and the T312 timer 210 expires, the UE 102 can be configured to declare early RLF instead of waiting for the T310 timer 208 to expire. In addition to the HO command, the UE 102 may be also configured to stop the T312 timer 210 based on received N311 consecutive in-sync indications. The N311 indications may be received from lower layers (e.g., L1/L2). The T312 timer 210 may be configured to have a shorter duration than the T310 timer 208.

In a beam failure detection procedure, a network can configure the UE 102 with a set of reference signals for monitoring the quality of the radio link. The set of reference signals may be referred to as q0 or beam failure detection reference signal (BFD-RS). BFD-RS may be configured to be spatially Quasi Co-Located (QCL'd) with physical downlink control channel (PDCCH) demodulation reference signal (DMRS). This means, that the BFD-RSs may be configured to correspond to downlink beams used to transmit PDCCH. DL beams may be identified by reference signal, for example, based on either synchronization signal/physical broadcast channel (SS/PBCH) block index or channel state information reference signal (CSI-RS) resource index. SS/PBCH block may refer to the signal block used for initial access and synchronization by the UE. Network may configure the BFD-RS list using RRC signaling or with combined RRC and MAC Control Element (CE) signaling, for example.

When the UE 102 is not explicitly configured with BFD-RS list, the UE 102 can determine the BFD-RS resources implicitly. For example, the UE 102 can determine the BFD-RS based on the configured/indicated/activated PDCCH transmission configuration indicator (PDCCH-TCI) states per control resource set (CORESET), e.g., the downlink reference signals (CSI-RS, SS/PBCH block) that are spatially QCL'd with PDCCH DMRS, or in other words, PDCCH beams.

The UE 102 can be further configured with a beam failure detection procedure. In beam failure detection, the UE 102 can assess the quality of the radio link periodically. The assessment may be performed by the physical layer of the UE 102. The quality of radio link may be estimated, for example, based on BFD-RS in the set of q0 and per BFD-RS. When the radio link condition of each BFD-RS in the beam failure detection set is considered to be in failure condition, a beam failure instance (BFI) indication may be provided to a higher layer (e.g., MAC). The beam failure condition may be determined by the UE 102, for example, based on that a hypothetical PDCCH BLER estimated using the BFD-RS is above a configured threshold. In one example, the BLER threshold value may correspond to the OoS threshold used for the radio link monitoring, such as OoS/Qout=10%. In case the at least one BFD-RS is not in a failure condition, no indication is provided to the higher layer.

The higher layer, e.g. the MAC layer, can implement a counter to count the BFI indications from the physical layer. If the BFI counter reaches a maximum value Q, the UE 102 may be configured to declare a beam failure. The maximum value Q can be configured by the network. For example, Q can be configured to be one of 1, 2, 4, 5, 6, 8 or 10. The BFI counter can be configured to be supervised by a BFI timer. For example, each time MAC receives a BFI indication from a lower layer, the BFI timer is started. Once the BFI timer expires, the BFI counter is reset by setting the counter value to zero.

Once a beam failure has been declared, the UE 102 may be configured to initiate a beam failure recovery (BFR) procedure. For example, the BFI counter and the associated BFI timer may be set such that the UE 102 is configured to declare the beam failure when two BFIs are detected within 5 ms apart from each other. Thereafter, the UE 102 may select and indicate, to the serving cell, a new candidate beam for PDCCH reception. The UE 102 can determine the new candidate beam based on e.g. L1-RSRP measurements. Indication of the candidate beam to the serving cell can be performed, for example, using either Contention-Based Random Access (CBRA) or Contention-Free Random Access (CFRA). Network can configure UE with candidate beam specific CFRA preambles, e.g., each candidate beam (synchronization signal block (SSB) or CSI-RS) can be indicated using dedicated signal (CFRA preamble). A specific threshold may be configured for the UE 102 so that if any of the new candidate beams (e.g., based on L1-RSRP measurements) are above the threshold, the UE 102 selects candidate beam from that set and performs CFRA. In case there are no beams above the configured threshold, UE can utilize contention based signaling to indicate the new candidate beam. For example, CBRA preamble resources can be mapped to specific downlink RS (SSB).

When both RLM and BFD procedures ran parallelly, this may create complexity for the UE 102 to implement two features (RLM and BFD) for the similar purposes. The parallel procedures also create complexity for the network side to align the behaviour of the two features to not to have a race condition (e.g., between the simultaneously running T310 timer and BFR procedure being not sure when will the expiry of first or the failure of other will trigger RLF).

An objective is to provide a unified RLM and BFD procedure with the aim to achieve a non-conflicting operation of RLM and BFD. In the unified procedure, in-sync and out-of-sync indications may be harmonized for RLM and BFD. In addition, the use of BFR duration may be harmonized with a radio link failure detection timer (e.g., T310). With the unified procedure, operations and related configurations between RLM, BFD and RLF reporting is provided, and wherein a recovery procedure for beam failure and radio link failure are coordinated and synchronized with respect to each other. In one example, the T310 timer is either disabled at a UE or not configured at all for the UE. The UE may be configured to disable usage of the T310 timer with respect to one or more specific cells when a configuration for BFR is received. Further, the UE may be configured to enable the radio link failure detection timer when the BFR is not configured to the UE to ensure RLF detection and recovery.

The unified RLM and BFD procedure may enable use of early radio link failure detection without use of an RLM-based timer for radio link failure detection, such as the T310 timer. This may be achieved via triggering an early RLF detection timer based on detected phases of beam failure detection and recovery procedure. In one example, the early RLF detection timer may be the T312 timer configured with different initiation and/or stopping criteria such that the initiation of the T312 timer is not dependent on the T310 timer. In one example, the early RLF detection timer may be a new timer configured for the UE. In order to differentiate the T312 timer from the T310 timer, when the T310 timer is lacking, the T312 timer is still initiated reactive to a measurement report sent, unlike T310 timer that is started after UE detects decrease a radio link problem.

In one example, the network (e.g., serving cell) may be configured to indicate radio link monitoring and beam failure detection parameters for the radio link monitoring. The parameters may be determined by a MAC layer of the respective network device. This enables adaption of radio link monitoring to many changes controlled by MAC layer, including changing the parameters according to indicated beams, use of CSI-RS or SSBs, for example. For example, the indicated parameters may include beam failure recovery configurations, radio link monitoring counters, radio link monitoring timers, beam failure detection counters and/or beam failure detection timers. The parameters may further include in sync and/or out of sync thresholds to be used by the UE.

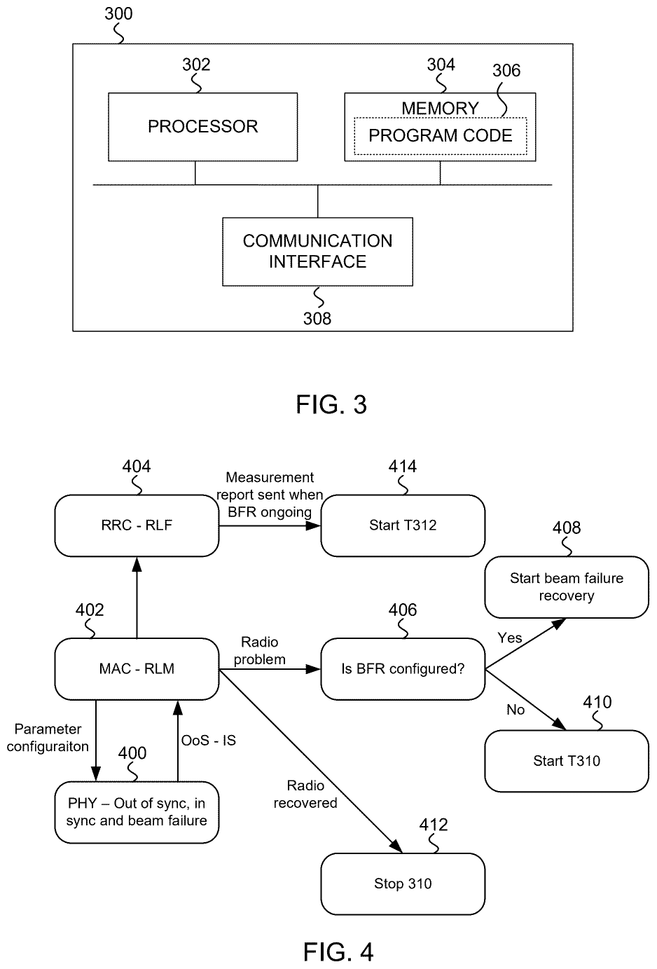

FIG. 3 illustrates an example of an apparatus configured to practice one or more example embodiments. Apparatus 300 may comprise a device such as UE 102, or an access node, an access point, a base station, a network device (e.g., gNB 104, 106), or a split portion thereof (e.g., a central or distributed unit of an access node), a terminal device, or in general any apparatus configured to implement functionality described herein.

Apparatus 300 may comprise at least one processor 302. The at least one processor 302 may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

Apparatus 300 may further comprise at least one memory 304. The memory 304 may be configured to store, for example, computer program code or the like, for example operating system software and application software. Memory 304 may comprise one or more volatile memory devices, one or more non-volatile memory devices, and/or a combination thereof. For example, the memory may be embodied as magnetic storage devices (such as hard disk drives, magnetic tapes, etc.), optical magnetic storage devices, or semiconductor memories (such as mask ROM, PROM (programmable ROM), EPROM (erasable PROM), flash ROM, RAM (random access memory), etc.). Memory 304 is provided as an example of a (non-transitory) computer readable medium. The term “non-transitory,” as used herein, is a limitation of the medium itself (i.e., tangible, not a signal) as opposed to a limitation on data storage persistency (e.g., RAM vs. ROM).

Apparatus 300 may further comprise a communication interface 308 configured to enable apparatus 300 to transmit and/or receive information. Communication interface 308 may comprise an external communication interface, such as for example a radio interface between UE 103 and base station(s) 104, 106, or a communication interface between a central unit and distributed unit(s) of a base station (e.g., an Fs-U and/or Fs-C interface). Communication interface 308 may comprise one or more radio transmitters or receivers, which may be coupled to one or more antennas or apparatus 300, or be configured to be coupled to one or more antennas external to apparatus 300.

Apparatus 200 may further comprise other components and/or functions such as a user interface (not shown) comprising at least one input device and/or at least one output device. The input device may take various forms such a keyboard, a touch screen, or one or more embedded control buttons. The output device may for example comprise a display, a speaker, or the like.

When apparatus 300 is configured to implement some functionality, some component and/or components of apparatus 300, such as for example the at least one processor 302 and/or the at least one memory 304, may be configured to implement this functionality. Furthermore, when the at least one processor 302 is configured to implement some functionality, this functionality may be implemented using program code 306 comprised, for example, in the at least one memory 304.

The functionality described herein may be performed, at least in part, by one or more computer program product components such as software components. According to an example embodiment, apparatus 300 comprises a processor or processor circuitry, such as for example a microcontroller, configured by the program code 306, when executed, to execute the embodiments of the operations and functionality described herein. Program code 306 is provided as an example of instructions which, when executed by the at least one processor 302, cause performance of apparatus 300.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), graphics processing units (GPUs), or the like.

Apparatus 300 may be configured to perform, or cause performance of, method(s) described herein or comprise means for performing method(s) described herein. In one example, the means comprises the at least one processor 302, the at least one memory 304 including instructions (e.g., program code 306) configured to, when executed by the at least one processor 302, cause apparatus 300 to perform the method(s). In general, computer program instructions may be executed on means providing generic processing functions. Such means may be embedded for example in a personal computer, a smart phone, a network device, or the like. The method(s) may be thus computer-implemented, for example, based on algorithm(s) executable by the generic processing functions, an example of which is the at least one processor 302. The means may comprise transmission or reception means, for example one or more radio transmitters or receivers, which may be coupled or be configured to be coupled to one or more antennas. Apparatus 300 may comprise, for example, a network device, for example, an access node, an access point, a base station, or a central/distributed unit thereof. Although apparatus 300 is illustrated as a single device, it is appreciated that, wherever applicable, functions of apparatus 200 may be distributed to a plurality of devices.

FIG. 4 illustrates an example of participation of different protocol layers of a device in the unified RLM and BFD procedure, according to an example embodiment. The device may be, for example, the UE 102.

Physical layer 400 of the device may be configured to provide indications of radio link quality to the higher layer (e.g., the MAC layer 402). The indications of radio link quality may comprise at least one of one or more of OoS indications, IS indications or indications related to a beam failure (e.g., BFI).

MAC layer 402 of the device may be responsible for radio link monitoring. The MAC layer 402 may be further configured to determine parameter configuration for beam failure detection, such as parameters related to the RLM and BFR procedures. The device may be configured to determine, based on indications of radio link quality received by the MAC layer 402 from the physical layer 400, that a radio problem is detected. When the radio problem is detected, the device may determine at 406 if a beam failure recovery procedure is configured. For example, the device may determine if the beam failure recovery procedure is configured to be used with certain cells. If BFR is configured, the device may determine to start the beam failure recovery procedure, at 408. If BFR is not configured, the device may determine to start the T310 timer at 410. Hence, usage of the T310 may be optional. For example, the device may be configured to use the T310 timer in case BFR is not configured. In other words, the device may be configured to disable usage of the T310 timer and use BFR procedure instead, in case a radio problem is detected. The usage of T310 may be disabled only for certain cells or network nodes while the BFR procedure is configured to be used. When the MAC layer 402 detects that the radio is recovered, e.g., an IS indication is received from the physical layer, the MAC layer 402 may determine to stop the T310 timer.

RRC layer 404 of the device may be responsible of radio link failure procedures. The device may be configured to detect when a measurement report, such as a L3 measurement report of a candidate cell, is triggered to be sent. The device may be further configured to check if a condition to initiate a timer for early RLF detection is met. The condition may be based on one or more indications related to a beam failure being detected when the L3 measurement report is sent. For example, the condition may be met when at least one of the BFR procedure is ongoing or one or more indications of a degraded radio link quality (e.g., BFI) is received at the time of transmission of the measurement report. The checking step may be performed prior to sending the measurement report, e.g. in response to detecting the trigger for the measurement report.

At 404, the device may determine to start the timer for early RLF detection based on the met condition. The timer may be, for example, the T312 timer which is configured to be initiated based on the condition associated with the BFR procedure (or in general a detected indication of a beam failure) instead of based on the triggered T310 timer. If at least one of a handover command is received in response to the measurement report or the BRF was successful, the RRC layer 404 may determine to stop the T312 timer. If the T312 timer expires, the RRC layer 404 may be configured to declare a radio link failure.

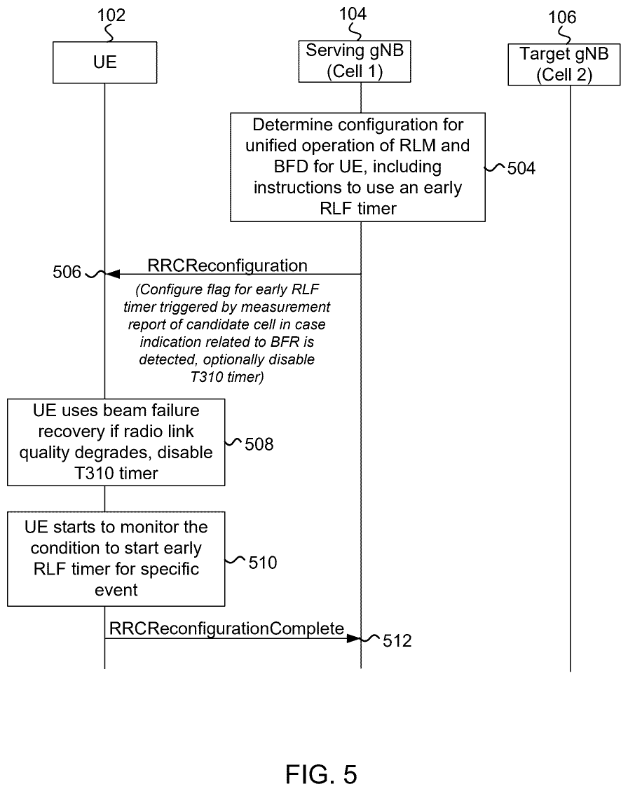

FIG. 5 illustrates an example of a message sequence chart for preparation of the unified RLM and BFD procedure, according to an example embodiment. The messages may be transmitted between a terminal device, such as the UE 102, and a network device, such as the gNB 104. In the scenario of FIG. 5, the gNB 104 may be a serving gNB of the UE 102.

At operation 504, the serving gNB 104 may be configured to determine initial configuration for the unified RLM and BFD procedure. The initial configuration may be sent by the serving gNB 104 to the UE 102, for example, during a handover procedure or after initial access of the UE 102 to the network via the gNB 104.

Before transmission of the initial configuration, the serving gNB 104 may be configured to evaluate one or more criteria or conditions for the unified operation of RLM and BFD. Based on the criteria/conditions, the serving gNB 104 defines corresponding configurations to be transmitted to the UE 102.

For example, the serving gNB 104 can determine that the UE 102 should not use a T310 timer, but instead the UE 102 should use a beam failure recovery procedure. The decision to use BFR may be based on that the serving cell is a cell with multiple beams (e.g., at least two beams). The decision may be further based on that the serving gNB 104 has observed, e.g., based on statistics, that the BFR procedure results in successful re-establishment of the connection. For example, if the statistics would indicate that BFR often fails for the UEs in the cell, or there would be only 1 or 2 beams, then the network could decide not to configure BFR to the UE 102. This enables, that use of T310 (or a corresponding radio link failure timer) can be avoided as the BFR also provides a way to trigger RLF to the UE 102. This may further enable faster resume of user data exchange for beam recovery than RLF recovery using T310.

The serving gNB 104 may further determine that the UE 102 should use early RLF detection timer (e.g., T312 or a new timer configured by the network), which timer is configured to be triggered by a measurement report sent by the UE 102 during a beam failure detection or an on-going BFR. The measurement report may be, for example, a L3 measurement of a candidate cell. For example, the measurement report may be configured to be triggered when a reference signal of a target gNB, such as the gNB 106, located in a second cell is an offset stronger than a reference cell of the serving gNB 104 located in a first cell. Alternatively, the measurement report may be configured to be triggered when the reference signal is stronger than a threshold.

The initial configuration may comprise at least an indication to use the early RLF detection timer, or a configuration for the early RLF detection timer. A duration of the early RLF detection timer may be set to be shorter than a duration of the radio link failure timer (e.g., T310) would be. Hence, the early RLF detection timer can trigger RLF earlier than when using T310, assuming that T310 and the early RLF detection timer would be triggered based on the same information. The indication to use the early RLF detection timer may be explicit or implicit. For example, when the UE 102 is not configured with T310 timer and receives/pre-stores the configuration for the early RLF detection timer, the UE 102 may infer that the early RLF timer is to be used when the measurement report is sent and at least one indication related to a beam failure has been detected.

The serving gNB 104 may be further configured to indicate, to the UE 102, that subsequent radio problem detection parameters will be provided for the UE 102 from a MAC layer. The radio problem detection parameters may comprise, for example, a value for at least one of N310, T310, Beam failure recovery procedure, BFI counter or BFI timer. The radio problem detection parameters may further comprise Qout/Qin thresholds. N310 refers to a counter for maximum number of consecutive out-of-sync indications sent for a PCell received from lower layers. PCell refers to a primary cell which is the main serving cell that provides the primary radio link to a UE. However, initial parameters may be signaled for the UE 102 by the RRC layer. Here, the initial parameters may be obtained by the RRC layer from the MAC layer of the gNB 104. The radio problem detection parameters may be transmitted by the gNB 104 to the UE 102. For example, the parameters may be transmitted via RRC signaling, e.g. in the message transmitted at 506 for initial configuration, or in one or more subsequent configuration messages.

In some examples, one or more radio problem detection parameters (e.g., the T310 value) can be indicated by the MAC layer to the UE 102 to adjust to radio situations in a more dynamic manner. The radio problem detection parameters may further comprise Qout/Qin thresholds. Said parameters can be dynamically indicated, to the UE 102 by the serving gNB 104, for example, via MAC messages sent by the gNB 104 to the UE 102. This enables the UE 102 to implement faster or slower radio problem detection, depending on the circumstances. For example, in cases where the radio signal quality is expected to vary a lot, Qout threshold can be decreased.

At operation 506, the initial configuration determined by the serving gNB 104 is sent to the UE 102. For example, the serving gNB 104 may transmit, to the UE 102, a message, e.g. RRC message. The RRC message may be, for example, RRC reconfiguration comprising instructions for operating with the unified RLM and BFD. The message may comprise an indication to disable the T310 timer at least for measurements performed on the serving gNB 104. The message may further comprise instructions to configure a flag for the early RLF detection timer for a candidate measurement report. For example, based on the flag the UE 102 can start the early RLF detection timer when the measurement report is sent after beam failure recovery is started. The message may further comprise the initial value for N310, BFI timer and/or BFI counter.

Based on the received message, at operation 508, the UE 102 may disable the T310 timer and use BFR if the UE 102 detects degradation of radio link quality. For example, the UE 102 may be instructed to initiate beam failure recovery if radio problem is indicated from lower layers.

Further, at operation 510, the UE 102 may start monitoring the condition to start the early RLF detection timer for a specific event. For example, responsive to sending a measurement report associated with the target gNB 106, e.g. each time the UE 102 sends a measurement report associated with the target gNB 106, the UE 102 may check for BFD or an on-going BFR. If BFD or on-going BFR is detected, the UE 102 is configured to trigger the early RLF detection timer. If the measurement report is sent while there is no on-going BFR or BFD event detected, the UE 102 may determine not to trigger the early RLF detection timer. In other examples, the measurement report may refer to any uplink message sent by the UE to the network out of which UE expects a response. Sending such an UL message and receiving no response may indicate the lack of good communication link between the UE and NW such that the early RLF detection timer can be started reactive to each UL message. The BFD event may be detected, for example, based on at least one of a detected BFI indication (e.g., the BFD counter has a current value above zero) or an ongoing BFI timer triggered by a latest detected BFI indication. Once the BFI timer expires (no BFI indications detected while the BFI timer is running), the UE 102 may be configured to reset the BFI counter to zero. If the BFI counter reaches the maximum value Q, the UE 102 may declare a beam failure and initiate the BFR procedure. The UE 102 may determine that the initiated BFR procedure is ongoing, for example, until a beam change command is received.

At operation 512, the UE 102 may be configured to send, to the serving gNB 104, an acknowledgment message for receipt of the configuration message and application of indicated configurations. The acknowledgement may be performed, for example, in a form of a RRCReconfigurationCompelete message.

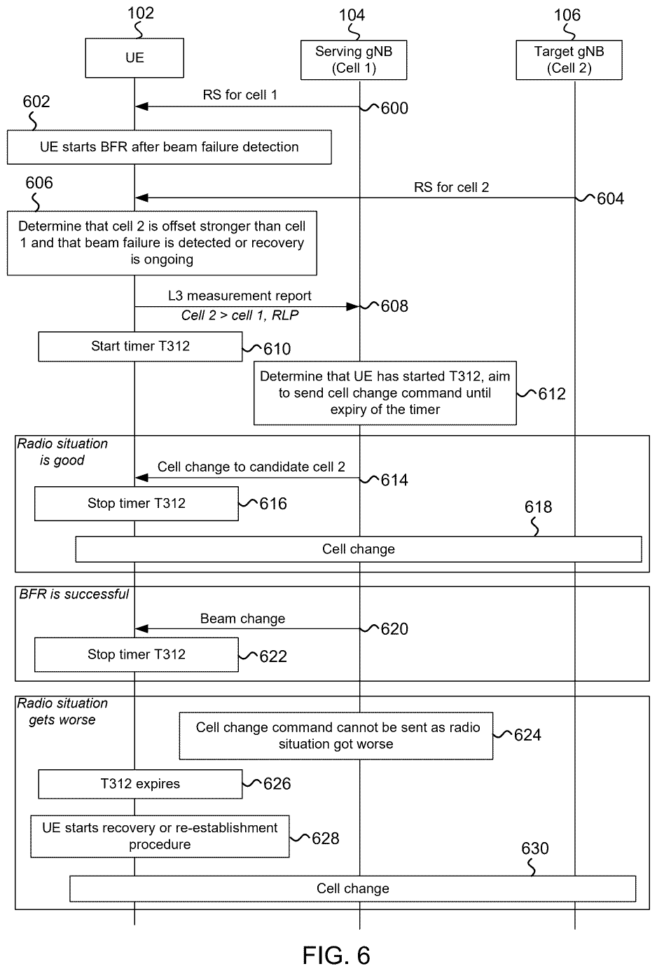

FIG. 6 illustrates an example of a message sequence chart for early RLF detection mechanism with beam failure detection, according to an example embodiment. The messages may be transmitted between a terminal device, such as the UE 102, and network devices, such as the gNB 104 and gNB 106. The gNB 104 may be currently serving the UE 102 at a first cell (Cell 1) and the gNB 106 (providing a second cell (Cell 2)) may be a target gNB for a cell change to a second cell. The message sequence of FIG. 6 may be a continuation of the message sequence of FIG. 5.

At operation 600, the UE 102 receives a reference signal for indicated beam of a radio link from the serving gNB 104. The UE may perform one or more measurements on the reference signal. The measurement results may indicate that radio link quality is below Qout threshold for N310 instances. The UE 102 may detect beam failure based on the measurement results. The UE 102 may then determine to start, at operation 602, the beam failure recovery procedure according to the initial configuration received by the UE 102 from the serving gNB 104.

At operation 604, the UE 102 receives a reference signal for the second cell from the target gNB 106. The UE may perform one or more measurements on the reference signal. The UE 102 may compare the measurements associated with the RS from the serving cell and the measurements associated with the target cell (candidate cell).

At operation 606, the comparison of the first cell (serving cell) with the second cell (candidate cell) triggers a measurement report, such as a L3 measurement report. The UE 102 further determines that the beam failure recovery triggered at operation 602 is on-going when sending the measurement report associated with the candidate cell. The UE 102 further determines that the initial configuration has an indication to start early RLF detection timer.

At operation 608, the UE 102 sends the L3 measurement report to the serving gNB 104. UE 102 may indicate to the serving gNB, e.g. in the message sent for the measurement report, that radio link problem is detected and/or the beam failure recovery is on-going.

At operation 610, the UE 102 starts the early RLF detection timer.

At operation 612, the serving gNB 104 may determine that the UE 102 has the early RLF detection timer on-going based on the received indication of the detected radio problem. The serving gNB 104 may then determine to prioritize a lower layer frequency for handover, for example, in case the preparation and indication of a detected radio link problem can be done faster. For example, an inter-frequency handover can be initiated before UE goes to cell edge, as such inter-frequency handover decision can be taken earlier compared to intra-frequency handover decision.

In case the radio situation is good, the serving gNB 5104 can be able to send a cell switch command to the UE 102 at operation 614. At operation 616, the UE 102 receives the message for cell switch and stops the timer for early RLF detection. At operation 618, the UE 102 executes cell switch from the first cell to the second cell based on the received cell switch command.

In case the beam failure recovery initiated at operation 602 is successful, the UE 102 can receive a beam change command from the serving gNB 500 at operation 620. At operation 622, the UE 102 stops the early RLF detection timer based on the received beam change command.

In case the radio situation gets worse, the serving gNB 104 may determine, at operation 624, that the cell change command cannot be sent to the UE 102. At this point, neither beam failure recovery nor the cell change may have been successful and hence, at operation 626, the early RLF detection timer expires at the UE 102.

After the early RLF detection timer has expired, at operation 628, the UE 102 may trigger RLF early and initiate re-establishment or recovery procedure.

At operation 630, the UE 102 may recover to a candidate cell, such as the second cell, and starts communicating with the target gNB 106 without having a long lasting radio link problem.

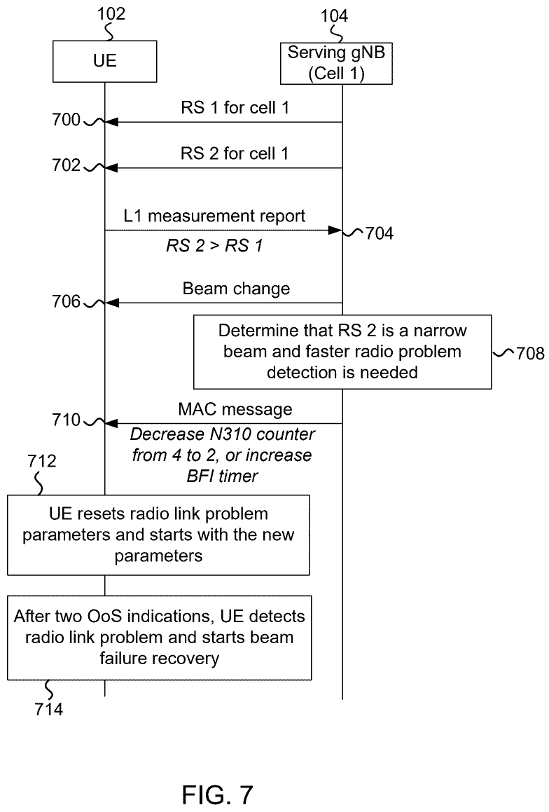

FIG. 7 illustrates an example of a message sequence chart for an early RLF detection mechanism and enabling MAC to change RLM configurations. The messages may be transmitted between a terminal device, such as the UE 102, and a network device, such as the gNB 104. The message sequence of FIG. 7 may be a continuation of the message sequence of FIG. 5.

The UE 102 has received, from a network device, e.g. the serving gNB 104, a first set of radio problem detection parameters for radio link monitoring. The first set of radio problem detection parameters may have been received 506 via RRC signaling, e.g. in RRC reconfiguration message. For example, the first set of radio problem detection parameters may be referred to as initial radio problem detection parameters. As another example, the first set of radio problem detection parameters may be referred to as previous radio problem detection parameters, which means that the first set of radio problem detection parameters is received before a second set of radio problem detection parameters. For example, the first set of radio detection parameters may comprise at least one of: N310 counter limit, BFI detection timer value, BFI counter limit, T310 value, Qout value. The initial radio problem detection parameters (e.g. first set) may be signaled by RRC, but RRC layer may obtain the initial parameters from the MAC layer. The first set of radio problem detection parameters may comprise at least one radio problem detection parameter.

The UE 102 may have received, from a network device, e.g. the serving gNB 104, an indication that an indication of a second set of radio problem detection parameters will be indicated via lower layer signaling, e.g. via a lower layer message, e.g. via MAC layer, e.g. via a MAC message. This indication may be received 506 via RRC signaling, e.g. in a RRC reconfiguration message. The second set of radio problem detection parameters may be referred to as subsequent radio problem detection parameters, new radio problem detection parameters, updated radio problem detection parameters, adjusted radio problem detection parameters, further radio problem detection parameters, for example. The second set of radio problem detection parameters may comprise at least one radio problem detection parameter.

An indication of the second set of radio problem detection parameters may refer to at least one radio problem detection parameter itself, or to an instruction to adjust the first set of radio problem detection parameters to obtain the second set of radio problem detection parameters.

At operation 700 the UE 102 receives a first reference signal (RS1) from the serving gNB 104. At operation 702, the UE 102 receives a second reference signal (RS2) from the serving gNB 104. Here, RS1 is the indicated beam of the UE 102. The UE 102 compares RS1 with RS2. For example, the UE 102 compares the signal strength of RS1 with RS2. Measures of the signal strength may comprise, for example, at least one of: reference signal received power, RSRP; reference signal received quality, RSRQ; or Signal to Interference plus Noise Ratio, SINR. The UE 102 determines that signal strength of RS2 is higher than RS1. The UE 102 sends, at operation 704, a (L1) measurement report to the serving gNB 104 indicating the comparison result.

At operation 706, the serving gNB 104 sends a beam change command to configure RS2 as the indicated beam of the UE 102 based on the received measurement report.

At operation 708, the serving gNB 104 may determine that RS2 is a narrow beam (e.g., CSI-RS) compared to broad beam RS1 (e.g., SSB). Thus, the serving gNB 104 may determine that the UE 102 has a higher chance to experience radio problems due to a narrow beam. The determination that the UE has a higher chance to experience radio problems may be performed, for example, at the MAC layer of the gNB 104. The MAC layer may then determine to configure the UE 102 with a faster radio link problem detection parameter compared to the RLM parameter used with the RS1. The radio link problem detection parameters may be associated with at least one of the RLM or BFD procedures. For example, the radio link problem detection parameters may comprise at least one of a N310 counter limit, a BFI timer value or a BFI counter limit. The radio link problem detection parameters may further comprise, for example, a threshold Qin, a threshold Qout, and/or a duration for the early RLF timer or T310. Faster parameter means that the parameter, e.g. N310 counter limit, is adjusted so that the radio link problem or radio link failure is detected with less severe problems. For example, the N310 counter limit may be decreased, as described in an example below.

In some examples, the gNB may determine that slower radio problem detection is needed. For example, if the radio conditions are rather stable, the radio problem detection parameters may be adjusted so that the radio link problem or radio link failure is detected with more severe problems. This way it may be avoided that the UE might not start beam failure recovery unnecessarily.

At operation 710, the UE 102 receives an indication of a second set of radio problem detection parameters, e.g. via a lower layer message. The second set of radio problem detection parameters may be referred to as subsequent parameters herein. For example, the UE 102 receives subsequent parameters for radio problem detection via lower layer signaling, e.g. via MAC signaling, e.g. MAC CE. For example, the MAC layer can indicate with MAC signaling to the UE 102 to decrease N310 counter limit. Alternatively, the MAC layer may indicate to the UE 102 to increase BFI timer (that is used to stop beam failure detection) and/or decrease the BFI counter limit. For example, the serving gNB 104 may send, to the UE 102, a MAC message comprising instructions to decrease the maximum number or consecutive OoS indications of the N310 counter from 4 to 2.

For example, the indication of the second set of radio problem detection parameters comprises at least one of: wherein the indication of the second set of radio problem detection parameters comprises at least one of: a decreased N310 counter limit; an increased N310 counter limit; an increased beam failure indication, BFI, detection timer value; a decreased BFI detection timer value; a decreased BFI max count; an increased BFI max count; an increased or decreased T310 value; an increased or decreased Qout value; beam failure recovery configuration or preamble; or a radio link monitoring reference signal.

For example, the indication of the second set of radio problem detection parameters comprises at least one instruction to adjust the first set of radio problem detection parameters to obtain the second set of radio problem detection parameters.

After the reception of new radio link problem detection parameters, at operation 712, the UE 102 resets the current evaluation of possible radio problems with the first set of radio problem detection parameters, and starts monitoring based on the received new parameters (the second set of radio problem detection parameters).

For example, the UE applies the second set of radio problem detection parameters for radio link monitoring. wherein applying the second set of radio problem detection parameters for radio link monitoring causes a radio link problem to be detected with less severe radio link problems than when applying the first set of radio problem detection parameters.

For example, the UE applies the second set of radio problem detection parameters for radio link monitoring. wherein applying the second set of radio problem detection parameters for radio link monitoring causes a radio link problem to be detected with more severe radio link problems than when applying the first set of radio problem detection parameters.

At operation 714, the UE 102 performs radio link monitoring based on the new parameters (radio link problem detection parameters or radio problem detection parameters), and may detect a radio link problem. For example, the UE may detect OoS indications. For example, if the N310 counter limit is configured as 2, then the 102 UE may start beam failure recovery after 2 OoS indications received from the physical layer to the MAC layer of the UE 102.

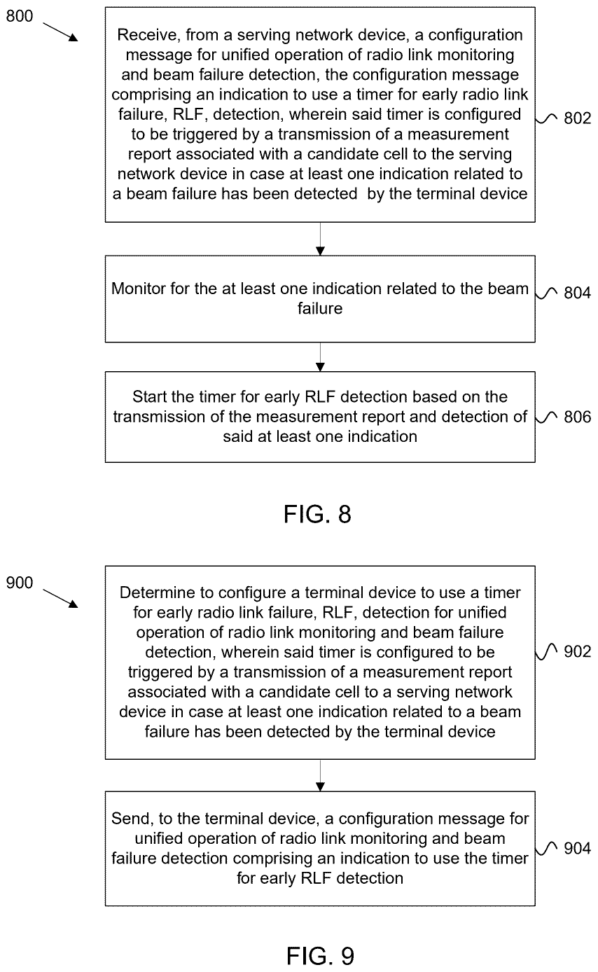

FIG. 8 illustrates an example of a method 800 for unified operation of RLM and BFD, according to an example embodiment. Method 800 may be performed by a terminal device, e.g., UE 102, or by a control apparatus configured to control the functioning thereof, when installed therein.

At operation 802, the method may comprise receiving, from a serving network device, a configuration message for unified operation of radio link monitoring and beam failure detection, the configuration message comprising an indication to use a timer for early radio link failure, RLF, detection, wherein said timer is configured to be triggered by a transmission of a measurement report associated with a candidate cell to the serving network device in case at least one indication related to a beam failure has been detected by the terminal device.

At operation 804, the method may comprise monitoring for the at least one indication related to the beam failure. The indication may be detected by the terminal device, for example, based on at least one of one or more one or more beam failure indications received by the terminal device or based on a beam failure recovery procedure ongoing at the terminal device.

At operation 806, the method may comprise starting the timer for early RLF detection based on the transmission of the measurement report and detection of said at least one indication. The method 800 may further comprise stopping the timer based on at least one of a cell change command or a beam change command received by the terminal device from the serving network device before expiry of the early RLF timer. The method 800 may further comprise declaring, by the terminal device, a radio link failure based on expiry of the early RLF timer.

FIG. 9 illustrates an example of a method 900 for configuring unified operation of RLM and BFD, according to an example embodiment. Method 900 may be performed by a network device, e.g., gNB 104, or by a control apparatus configured to control the functioning thereof, when installed therein.

At operation 902, the method may comprise determining to configure a terminal device to use a timer for early radio link failure, RLF, detection for unified operation of radio link monitoring and beam failure detection, wherein said timer is configured to be triggered by a transmission of a measurement report associated with a candidate cell to a serving network device in case at least one indication related to a beam failure has been detected by the terminal device.

At operation 904, the method may comprise sending, to the terminal device, a configuration message for unified operation of radio link monitoring and beam failure detection comprising an indication to use the timer for early RLF detection. In one example, the configuration message may further comprise initial parameters to be used by the terminal device for detection of the beam failure. The initial parameters may be received by the network device from a MAC layer of the network device. The MAC layer may be configured to determine at least one of a maximum number of consecutive out-of-sync indications, a beam failure indication counter value or a beam failure indication timer as the initial parameters. In one example, the configuration message may comprise an indication to disable usage of a timer for RLF detection (e.g., T310 timer) when the terminal device is configured to use the timer for early RLF detection.

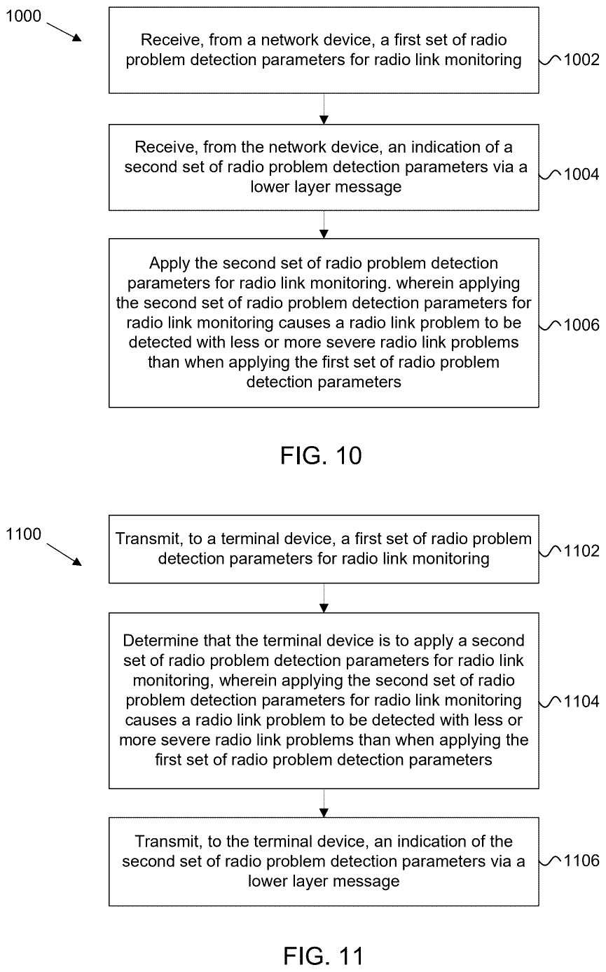

FIG. 10 illustrates an example of a method 1000 for radio problem detection parameter updates, according to an example embodiment. Method 800 may be performed by a terminal device, e.g., UE 102, or by a control apparatus configured to control the functioning thereof, when installed therein.

At operation 1002, the method may comprise receiving, from a network device, a first set of radio problem detection parameters for radio link monitoring.

At operation 1004, the method may comprise receiving, from the network device, an indication of a second set of radio problem detection parameters via a lower layer message. The lower layer message may be, for example, a MAC message.

At operation 1006, the method may comprise applying the second set of radio problem detection parameters for radio link monitoring, wherein applying the second set of radio problem detection parameters for radio link monitoring causes a radio link problem to be detected with less or more severe radio link problems than when applying the first set of radio problem detection parameters.

FIG. 11 illustrates an example of a method 1100 for configuring radio problem detection parameters, according to an example embodiment. Method 1100 may be performed by a network device, e.g., gNB 104, or by a control apparatus configured to control the functioning thereof, when installed therein.

At operation 1102, the method may comprise transmitting, to a terminal device, a first set of radio problem detection parameters for radio link monitoring.

At operation 1104, the method may comprise determining that the terminal device is to apply a second set of radio problem detection parameters for radio link monitoring, wherein applying the second set of radio problem detection parameters for radio link monitoring causes a radio link problem to be detected with less or more severe radio link problems than when applying the first set of radio problem detection parameters.

At operation 1106, the method may comprise transmitting, to the terminal device, an indication of the second set of radio problem detection parameters via a lower layer message. The lower layer message may be, for example, a MAC message.

Further features of the methods directly result for example from functionality of UE 102, or gNB(s) 104, 106, as described throughout the description, claims, and drawings, and are therefore not repeated here. An apparatus, for example a device such as UE 102, or an access node, may be configured to perform or cause performance of any aspect of the method(s) described herein. Further, a computer program, a computer program product, or a (non-transitory) computer-readable medium may comprise instructions for causing, when executed by an apparatus, the apparatus to perform any aspect of the method(s) described herein. Further, an apparatus may comprise means for performing any aspect of the method(s) described herein. According to an example embodiment, the means comprises at least one processor; and at least one memory storing instructions that, when executed by the at least one processor, cause the apparatus at least to perform any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the example embodiments described above may be combined with aspects of any of the other example embodiments described to form further example embodiments without losing the effect sought.

The term ‘comprising’ is used herein to mean including the method, blocks, or elements identified, but that such blocks or elements do not comprise an exclusive list and a method or apparatus may contain additional blocks or elements.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

Although subjects may be referred to as ‘first’ or ‘second’ subjects, this does not necessarily indicate any order or importance of the subjects. Instead, such attributes may be used solely for the purpose of making a difference between subjects.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

Some additional examples:

Example 1. A terminal device, comprising: at least one processor; and at least one memory storing instructions that, when executed by the at least one processor, cause the terminal device at least to: receive, from a network device, a first set of radio problem detection parameters for radio link monitoring; receive, from the network device, an indication of a second set of radio problem detection parameters via a lower layer message; and apply the second set of radio problem detection parameters for radio link monitoring. wherein applying the second set of radio problem detection parameters for radio link monitoring causes a radio link problem to be detected with less or more severe radio link problems than when applying the first set of radio problem detection parameters.

Example 2. The terminal device of example 1, wherein the instructions, when executed by the at least one processor, further cause the terminal device to: receive, from the network device, an indication that the indication of the second set of radio problem detection parameters will be indicated via the lower layer message.

Example 3. The terminal device of example 1 or 2, wherein the lower layer message is a medium access control, MAC, message.

Example 4. The terminal device of any preceding example, wherein the instructions, when executed by the at least one processor, further cause the terminal device to: receive a first reference signal from the network device; receive a second reference signal from the network device; perform at last one measurement on the first reference signal and the second reference signal; transmit, based on the at least one measurement on the first reference signal and the second reference signal, a measurement report to the network device.

Example 5. The terminal device of example 4, wherein the first reference signal is an indicated beam of the terminal device.

Example 6. The terminal device of example 5, wherein the instructions, when executed by the at least one processor, further cause the terminal device to: perform, based on the at least one measurement, a comparison of the first reference signal and the second reference signal; determine, based on the comparison, that the second reference signal is stronger than the first reference signal; and wherein the measurement report comprises a result of the comparison.

Example 7. The terminal device of example 6, wherein the instructions, when executed by the at least one processor, further cause the terminal device to:
receive, from the network device, a beam change command to configure the second reference signal as an indicated beam of the terminal device.

Example 8. The terminal device of any preceding example, wherein the indication of the second set of radio problem detection parameters comprises at least one of: a decreased N310 counter limit; an increased N310 counter limit; an increased beam failure indication, BFI, detection timer value; a decreased BFI detection timer value; a decreased BFI max count; an increased BFI max count; an increased or decreased T310 value; an increased or decreased Qout value; beam failure recovery configuration or preamble; or a radio link monitoring reference signal.

Example 9. The terminal device of any of the examples 1 to 7, wherein the indication of the second set of radio problem detection parameters comprises at least one instruction to adjust the first set of radio problem detection parameters to obtain the second set of radio problem detection parameters.

Example 10. A network device, comprising: at least one processor; and at least one memory storing instructions that, when executed by the at least one processor, cause the network device at least to: transmit, to a terminal device, a first set of radio problem detection parameters for radio link monitoring; determine that the terminal device is to apply a second set of radio problem detection parameters for radio link monitoring, wherein applying the second set of radio problem detection parameters for radio link monitoring causes a radio link problem to be detected with less or more severe radio link problems than when applying the first set of radio problem detection parameters; and transmit, to the terminal device, an indication of the second set of radio problem detection parameters via a lower layer message.

Example 11. The network device of example 10, wherein the instructions, when executed by the at least one processor, further cause the network device to: transmit, to the terminal device, an indication that the indication of the second set of radio problem detection parameters will be indicated via the lower layer message.

Example 12. The network device of example 10 or 11, wherein the determining that the terminal device is to apply the second set of radio problem detection parameters for radio link monitoring is based on a measurement report received from the terminal device.

Example 13. The network device of any of the examples 10 to 12, wherein the instructions, when executed by the at least one processor, further cause the network device to: transmit a first reference signal to the terminal device, wherein the first reference signal is an indicated beam of the terminal device; transmit a second reference signal to the terminal device; and receive a measurement report comprising at least one measurement result of the first reference signal and the second reference signal or a result of a comparison of the first reference signal and the second reference signal.

Example 14. The network device of example 13, wherein the instructions, when executed by the at least one processor, further cause the network device to: determine, based on the measurement report, that the second reference signal is stronger than the first reference signal.

Example 15. The network device of example 14, wherein the instructions, when executed by the at least one processor, further cause the network device to: transmit, to the terminal device, a beam change command to configure the second reference signal as an indicated beam of the terminal device.

Example 16. The network device of any of the examples 10 to 15, wherein the indication of the second set of radio problem detection parameters comprises at least one of: a decreased N310 counter limit; an increased N310 counter limit; an increased beam failure indication, BFI, detection timer value; a decreased BFI detection timer value; a decreased BFI max count; an increased BFI max count; an increased or decreased T310 value; an increased or decreased Qout value; beam failure recovery configuration or preamble; or a radio link monitoring reference signal.

Example 17. The network device of any of the examples 10 to 15, wherein the indication of the second set of radio problem detection parameters comprises at least one instruction to adjust the first set of radio problem detection parameters to obtain the second set of radio problem detection parameters.

Example 18. A method, comprising: receiving, by a terminal device from a network device, a first set of radio problem detection parameters for radio link monitoring; receiving, by the terminal device from the network device, an indication of a second set of radio problem detection parameters via a lower layer message; and applying, by the terminal device, the second set of radio problem detection parameters for radio link monitoring, wherein applying the second set of radio problem detection parameters for radio link monitoring causes a radio link problem to be detected with less or more severe radio link problems than when applying the first set of radio problem detection parameters.

Example 19. A method, comprising: transmitting, by a network device to a terminal device, a first set of radio problem detection parameters for radio link monitoring; determining, by the network device, that the terminal device is to apply a second set of radio problem detection parameters for radio link monitoring, wherein applying the second set of radio problem detection parameters for radio link monitoring causes a radio link problem to be detected with less or more severe radio link problems than when applying the first set of radio problem detection parameters; and transmitting, by the network device to the terminal device, an indication of the second set of radio problem detection parameters via a lower layer message.

1. A terminal device, comprising:
at least one processor;
and at least one memory storing instructions that, when executed by the at least one processor, cause the terminal device at least to:
receive, from a serving network device, a configuration message for unified operation of radio link monitoring and beam failure detection, the configuration message comprising an indication to use a timer for early radio link failure, RLF, detection, wherein said timer is configured to be triggered by a transmission of a measurement report associated with a candidate cell to the serving network device in case at least one indication related to a beam failure has been detected by the terminal device;
monitor for the at least one indication related to the beam failure;
start the timer for early RLF detection based on the transmission of the measurement report and detection of said at least one indication.

2. The terminal device of claim 1, wherein the instructions, when executed by the at least one processor, further cause the terminal device to:
declare radio link failure based on expiry of the timer for early RLF detection.

3. The terminal device of claim 1, wherein the instructions, when executed by the at least one processor, further cause the terminal device to:
determine that said at least one indication has been detected based on at least one of one or more beam failure indications received by the terminal device or based on a beam failure recovery procedure ongoing at the terminal device.

4. The terminal device of claim 1, wherein the instructions, when executed by the at least one processor, further cause the terminal device to:
determine that a reference signal of the candidate cell is an offset stronger than a reference signal of a serving cell or stronger than a threshold; and
perform the transmission of the measurement report associated with the candidate cell to the serving network device based on the determination.

5. The terminal device of claim 1, wherein the instructions, when executed by the at least one processor, further cause the terminal device to:
determine that said at least one indication has been detected; and
based on the determination, include an indication that the timer for early RLF detection is started to the measurement report associated with the candidate cell.

6. The terminal device of claim 1, wherein the instructions, when executed by the at least one processor, further cause the terminal device to:
receive, from the serving network device, at least one of a cell change command or a beam change command; and
determine to stop the timer for early RLF detection based on at least one of the cell change command or the beam change command received before expiry of the timer for early RLF detection.

7. The terminal device of claim 1, wherein the configuration message further comprises an indication to disable usage of a timer for RLF detection configured to be triggered based on radio link monitoring when the timer for early RLF detection is configured to be used; and
wherein the instructions, when executed by the at least one processor, further cause the terminal device to:
disable, based on the indication, trigger of the timer for RLF detection based on radio link monitoring performed on the serving network device.

8. The terminal device of claim 7, wherein the timer for RLF detection is a T310 timer.

9. The terminal device of claim 1, wherein the timer for early RLF detection is a T312 timer.

10. The terminal device of claim 1, wherein the configuration message further comprises initial parameters for triggering the beam failure detection, the initial parameters comprising at least one of a maximum number of consecutive out-of-sync indications, a beam failure indication timer or a beam failure indication counter value.

11. The terminal device of claim 10, wherein the configuration message further comprises an indication that subsequent parameters are received via a medium access control message; and wherein the instructions, when executed by the at least one processor, further cause the terminal device to:
receive the parameters via the medium access message; and
apply the parameters received via the medium access control message for radio problem detection.

12. A network device, comprising:
at least one processor; and
at least one memory comprising instructions which, when executed by the at least one processor, cause the network device at least to:
determine to configure a terminal device to use a timer for early radio link failure, RLF, detection for unified operation of radio link monitoring and beam failure detection, wherein said timer is configured to be triggered by a transmission of a measurement report associated with a candidate cell to a serving network device in case at least one indication related to a beam failure has been detected by the terminal device; and
send, to the terminal device, a configuration message for unified operation of radio link monitoring and beam failure detection comprising an indication to use the timer for early RLF detection.

13. The network device of claim 12, wherein the instructions, when executed by the at least one processor, further cause the network device to:
receive, from the terminal device, the measurement report associated with a candidate cell comprising an indication that said timer is started; and
prioritize transmission of a cell change command to the terminal device based on the received indication.

14. The network device of claim 12, wherein the terminal device is determined to be configured for the unified operation based on the network device being a serving network node of the terminal device and supporting multiple beam operation.

15. The network device of claim 14, wherein the instructions, when executed by the at least one processor, further cause the network device to:
determine, based on statistical information, that beam failure recovery procedure results in successful re-establishment of connection; and
determine to configure the terminal device for the unified operation based on the determination.

16. The network device of claim 12, caused to:
obtain, from a medium access control layer of the network device, initial parameters for the beam failure detection comprising at least one of a maximum number of consecutive out-of-sync indications, a beam failure indication timer or a beam failure indication counter value to be used by the terminal device for the beam failure detection; and
wherein the configuration message further comprises the initial parameters.

17. The network device of claim 16, wherein the configuration message comprises an indication that subsequent parameters are received by the terminal device via a medium access control message, and the instructions, when executed by the at least one processor, further cause the network device to:
determine said parameters by the medium access control layer; and
send the determined parameters to the terminal device via the medium access control message.

18. (canceled)

19. The network device of claim 12, wherein the measurement report associated with the candidate cell is received from the terminal device when a reference signal of the candidate cell if an offset stronger than a reference signal of a serving cell or stronger than a threshold.

20. The network device of claim 12, wherein the configuration message further comprises an indication to disable use of a timer for RLF detection configured to be triggered based on radio link monitoring when the timer for early RLF detection is configured to be used by the terminal device.

21. A method, comprising:
receiving, by a terminal device from a serving network device, a configuration message for unified operation of radio link monitoring and beam failure detection, the configuration message comprising an indication to use a timer for early radio link failure, RLF, detection, wherein said timer is configured to be triggered by a transmission of a measurement report associated with a candidate cell to the serving network device in case at least one indication related to a beam failure has been detected by the terminal device;
monitoring for the at least one indication related to the beam failure;
starting the timer for early RLF detection based on the transmission of the measurement report and detection of said at least one indication.

22. (canceled)
